(19) United States
(12) Patent Application Publication
(10) Pub. No.: US 2024/0080738 A1
(43) Pub. Date: Mar. 7, 2024

(54) OPTIMIZED RADIO LINK FAILURE RECOVERY FOR CELLS REPORTED IN MEASUREMENT REPORT

(71) Applicant: QUALCOMM Incorporated, San Diego, CA (US)

(72) Inventors: Muralidharan MURUGAN, Hyderabad, Telangana (IN); Nitin PANT, San Diego, CA (US); Jun DENG, Shanghai (CN); Rishika TINDOLA, Hyderabad, Telangana (IN); Sham Sunder KANTAYAPALEM, Hyderabad, Telangana (IN); Uttam VYAS, Hyderabad, Telangana (IN)

(21) Appl. No.: 18/261,476

(22) PCT Filed: Apr. 1, 2021
(86) PCT No.: PCT/CN2021/084875

§ 371 Date: Jul. 13, 2023

(51) Int. Cl. H04W 36/30; H04W 36/00

(52) U.S. Cl. CPC H04W 36/305; H04W 36/0058

(57) ABSTRACT

Techniques for recovering quickly from a radio link failure (RLF) by identifying potentially strong candidate cells, while avoiding the conventional delays from relying only on initial ACQ DB scans followed by band-scanning, are disclosed. In one aspect, a wireless apparatus such as a user equipment (UE) may identify a radio link failure (RLF) of an existing wireless connection. The UE may prioritize, during an RLF recovery procedure for restoring the connection, candidate cells using connection criteria from one or more measurement reports. The UE can thereupon restore the connection using a cell having a highest priority. In various configurations, the UE can use cells from A3, A4, A5, inter-RAT or periodic measurement reports to reestablish a stronger connection in a faster time.

### CROSS REFERENCE TO RELATED APPLICATION(S)

This application is a National Phase entry of PCT Application No. PCT/CN2021/084875, entitled “OPTIMIZED RADIO LINK FAILURE RECOVERY FOR CELLS REPORTED IN MEASUREMENT REPORT” and filed on Apr. 1, 2021, which is expressly incorporated by reference herein in its entirety.

### TECHNICAL FIELD

The present disclosure generally relates to communication systems, and more particularly, to recovering from radio link failures in wireless connections.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A user equipment (UE) may experience a radio link failure (RLF) during a wireless connection for a number of reasons. Often, RLF occurs as a result of a gradual or sudden drop in signal quality. Signal quality deterioration is typically precipitated by device interference arising from factors like moving obstacles, changing terrain, increasing distances from base stations, other signals in or near the same frequency band, and the like. Upon occurrence of an RLF in connected mode, it is desirable to recover and reestablish the link as quickly and seamlessly as possible. Conventionally, a UE may perform cell selection in a radio resource control (RRC) connection reestablishment procedure. As part of cell selection in this RRC mode, the UE scans the frequencies of last camped cells and other cells in the UE's acquisition database (ACQ DB). In the case where none of the cells in the ACQ DB are suitable to reestablish the connection (e.g., the respective signal qualities are insufficient), the UE may next trigger a band scan to effect a more comprehensive scan of different frequencies. These band scans may be time consuming and may delay RLF recovery. In another case where the UE finds a suitably strong cell during recovery but the cell is recognizably not a preferred cell of the UE, the UE may spend additional time scanning frequencies to find a preferred cell before reestablishing a link. Recovering from RLF can consequently result in long delays, and in some cases the selection of cells that considerably reduce throughput.

Accordingly, in one configuration, as an alternative to simply scanning the last camped cells in the ACQ DB, followed where needed by band-scanning, the UE may prioritize candidate cells reported in the measurement reports including, for example, the A3/A4/A5, inter-radio access technology (RAT) or periodic measurement reports using connection criteria such as one or more reported measurements of signal strength, signal quality, signal-to-noise ratio, or the like. The connection criteria may include as-reported values of these parameters, or weighted or averaged values of these parameters instead. These connection criteria may include, for example, reference signal received power (RSRP), reference signal received quality (RSRQ), a received signal strength indicator (RSSI), or another measurement quantity. The connection is thereupon restored using the connection criteria to identify a candidate cell having the highest priority. A cell with the highest priority may correspond, for example, to the candidate cell with the highest signal strength. In one configuration, prioritization is restricted to cells that satisfy a minimum measurement quantity threshold value to ensure that weak cells are not prioritized. If the measurement reports do not yield favorable candidate cells, the UE can continue cell selection based on the conventional ACQ DB.

In another configuration, when RLF occurs the UE can perform cell selection beginning with prioritizing strong cells based on the measurement reports as described above. In this configuration, however, the UE may give initial or special priority to cells from the measurement reports that belong to a preferred cell database corresponding to a feature supported by the UE. Examples of such preferred criteria may include HST (high speed transport) or, in the case of LTE, E-TRAN dual connectivity (ENDC), among others.

In an aspect of the disclosure, a method, a computer-readable medium, and an apparatus are provided. The apparatus includes one or more memories, and one or more processors each communicatively coupled with at least one of the one or more memories. The one or more processors, individually or in any combination, are operable to cause the apparatus to identify a radio link failure (RLF) of an existing wireless connection, prioritize, during an RLF recovery procedure for restoring the connection, candidate cells using connection criteria from one or more measurement reports, and restore the connection using the candidate cell having a highest priority.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a base station and user equipment (UE) in an access network.

FIG. 4 is a flowchart of a method of wireless communication.

FIG. 5 is a timing diagram illustrating a technique for cell selection.

FIG. 6 is a depiction of database or table entries used during cell selection.

FIG. 7 is a flowchart of a method of wireless communication.

FIG. 8 is a flowchart of a method of wireless communication.

FIG. 9 is a flowchart of a method of wireless communication.

FIG. 10 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

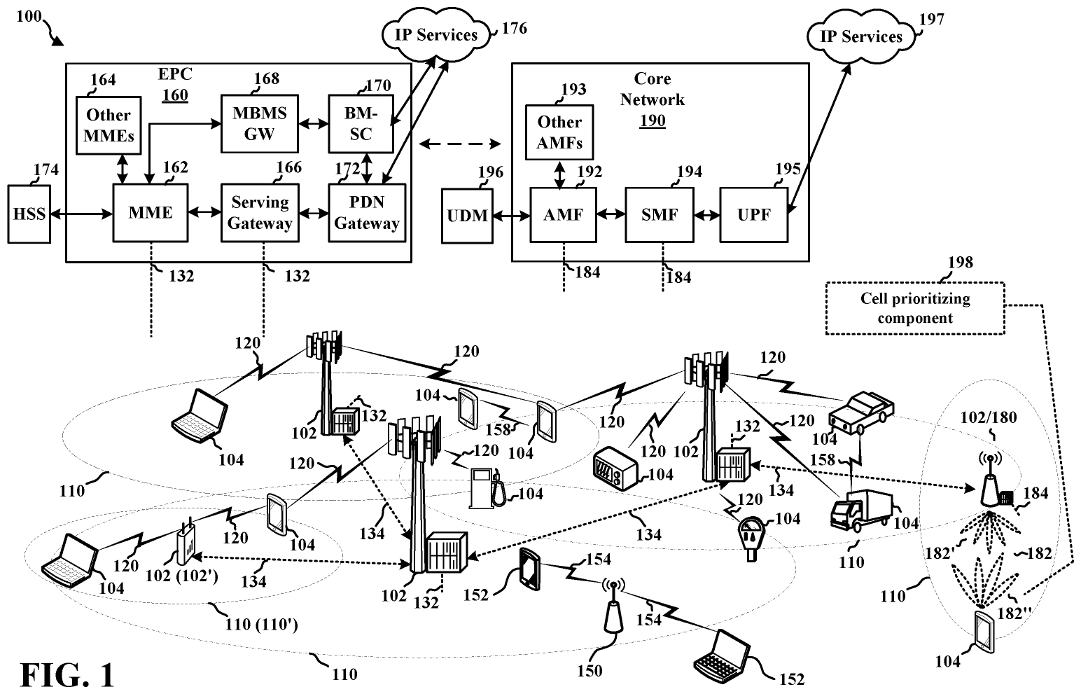

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR), which may be collectively referred to as Next Generation radio access network (RAN) (NG-RAN), may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless. At least some of the base stations 102 may be configured for integrated access and backhaul (IAB). Accordingly, such base stations may wirelessly communicate with other such base stations. For example, at least some of the base stations 102 configured for IAB may have a split architecture that includes at least one of a central unit (CU), a distributed unit (DU), a radio unit (RU), a remote radio head (RRH), and/or a remote unit, some or all of which may be collocated or distributed and/or may communicate with one another. In some configurations of such a split architecture, the CU may implement some or all functionality of a radio resource control (RRC) layer, whereas the DU may implement some or all of the functionality of a radio link control (RLC) layer.

Illustratively, some of the base stations 102 configured for IAB may communicate through a respective CU with a DU of an IAB donor node or other parent IAB node (e.g., a base station), further, may communicate through a respective DU with child IAB nodes (e.g., other base stations) and/or one or more of the UEs 104. One or more of the base stations 102 configured for IAB may be an IAB donor connected through a CU with at least one of the EPC 160 and/or the core network 190. In so doing, the base station(s) 102 operating as an IAB donor(s) may provide a link to the one of the EPC 160 and/or the core network 190 for other IAB nodes, which may be directly or indirectly (e.g., separated from an IAB donor by more than one hop) and/or one or more of the UEs 104, both of which may have communicate with a DU(s) of the IAB donor(s). In some additional aspects, one or more of the base stations 102 may be configured with connectivity in an open RAN (ORAN) and/or a virtualized RAN (VRAN), which may be enabled through at least one respective CU, DU, RU, RRH, and/or remote unit.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to downlink and uplink (e.g., more or fewer carriers may be allocated for downlink than for uplink). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to include cell prioritizing component 198. As discussed herein in various configurations, cell prioritizing component 198 may be configured, upon identifying an RLF, to consider different connection criteria included in (or derived from) measurement reports that have been provided to the UE to date, in lieu of simply reviewing the prior camped-on cells in the ACQ DB. Cell prioritizing component 198 may in some configurations review connection criteria relating to signal strength included in A3, A4, or A5 measurement reports, for example, or in inter-RAT or periodic measurement reports and other measurement reports that may have been received at the UE prior to RLF and that may include signal quality or link-based information. Cell prioritizing component 198 may review this criteria, such as reference signal received power (RSRP), reference signal received quality (RSRQ), received signal strength indicator (RSSI), signal-to-noise ratios, and other parameters that may be provided. Connection criteria reviewed by the cell prioritizing component 198 may not just include the values from the reports without more; in other configurations, prioritizing component 198 may consider average values over time, absolute values, average powers or other values corresponding to cells over a plurality of most recently received measurement reports, and other similar connection criteria that would enable the prioritizing component 198 to prioritize, or rank, the quality or desirability of cells in the event RLF occurs so that the connection can be reestablished (e.g., via an RRC Connection Reestablishment procedure) as quickly and efficiently as possible.

In other configurations described further herein, the connection criteria may also relate to preferred cell features, such as any one or more of high-speed transport (HST), Evolved Universal Terrestrial Radio Access Network Dual Connectivity (ENDC), evolved multimedia broadcast/multicast service (eMBMS), or closed subscriber group (CSG). It may be the case that prior to RLF, the cell was communicating via one of these features, or another preferred feature provided in a governing standard or from a wireless carrier. Cell prioritizing component 198 may identify one or more candidate cells that belong to a preferred cell database corresponding to one or more of these features, in which case the link or connection can be reestablished using the preferred feature. In some configurations, the cell prioritizing component 198 involves first prioritizing cells that include preferred features corresponding to the UE that lost the connection, and thereafter prioritizing cells based on signal quality as described above. In other configurations, either or both of these prioritization techniques may, to ensure that weak links are not selected, only prioritize those cells that have some minimum threshold signal power, such as some RSRPₜₕᵣₑₛₕ value, for example. In this way, cell prioritization component 198 will only prioritize cells that can viably be used in a connection, whether based primarily on signal power, preferred features, or otherwise.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies. In these cases, different radio access technologies may correspond to different preferred features, and cell prioritization component 198 may prioritize cells with distinct preferred features not only depending on the requirements of the UE, but also on the specific RAT in employment.

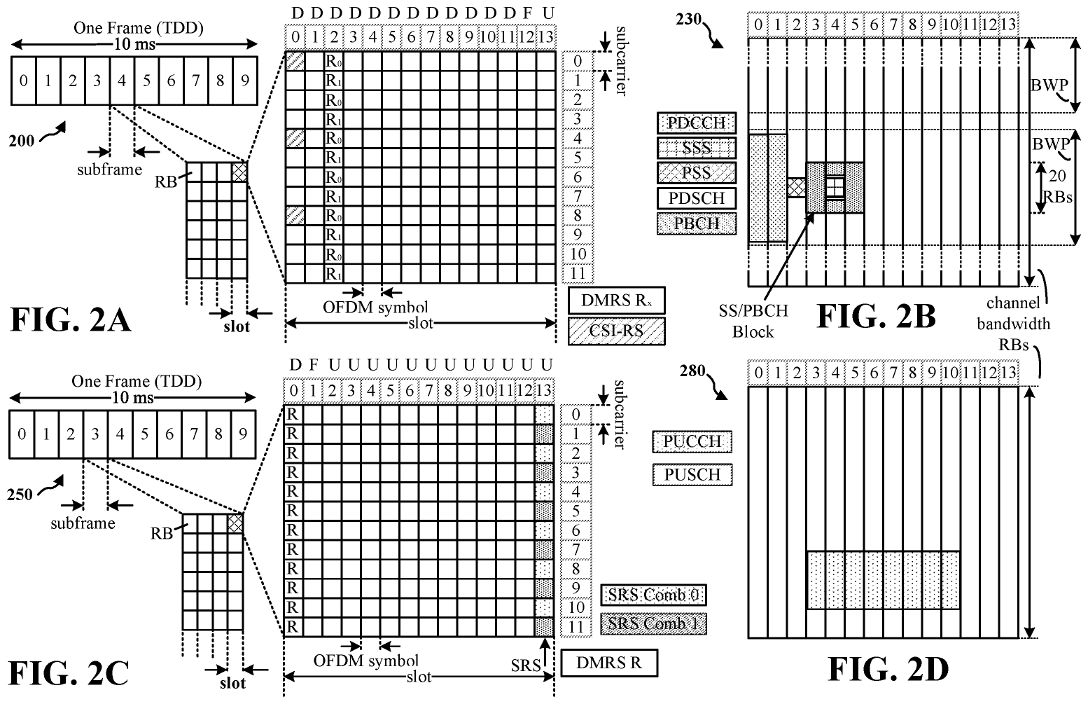

FIG. 2A is a diagram 200 illustrating an example of a first subframe within a 5G NR frame structure. FIG. 2B is a diagram 230 illustrating an example of downlink channels within a 5G NR subframe. FIG. 2C is a diagram 250 illustrating an example of a second subframe within a 5G NR frame structure. FIG. 2D is a diagram 280 illustrating an example of uplink channels within a 5G NR subframe. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot and/or reference signal (RS) for the UE. In some configurations, an RS may include at least one demodulation RS (DM-RS) (indicated as Rₓ for one particular configuration, where 100x is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIGs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), such as scheduling requests (SRs), a channel quality indicator (CQI), a precoding matrix indicator (PMI), a rank indicator (RI), and hybrid automatic repeat request (HARD) acknowledgement (ACK)/non-acknowledgement (NACK) feedback. The PUSCH carries data, and may additionally be used to carry a buffer status report (BSR), a power headroom report (PHR), and/or UCI.

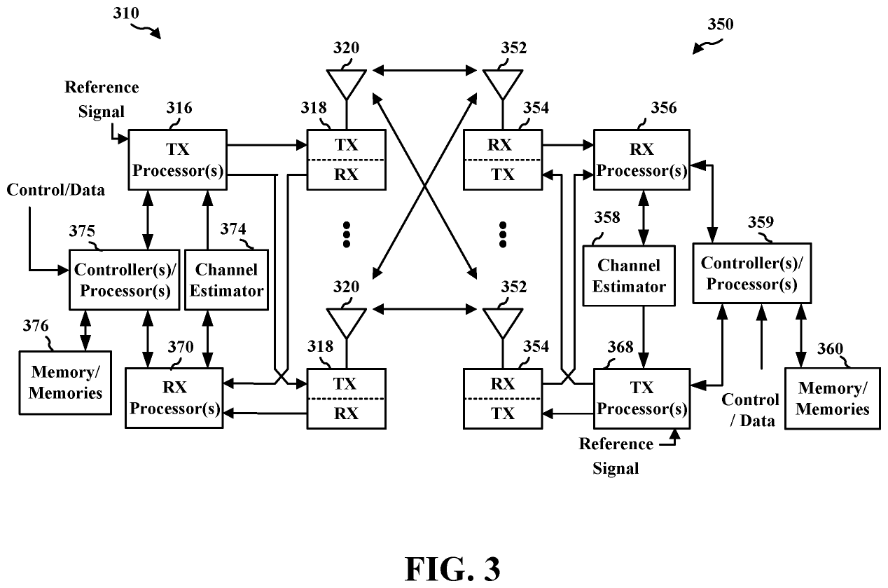

FIG. 3 is a block diagram of a base station 310 in communication with a UE 350 in an access network. In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation and coding schemes (MCS) (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359, which implement layer 3 and layer 2 functionality.

The one or more controllers/processors 359 may each be associated with one or more memories 360 that store program codes and data. The one or more memories 360, individually or in any combination, may be referred to as a computer-readable medium. In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the base station 310, the one or more controllers/processors 359 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium. In the UL, the one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359 may be configured to perform aspects in connection with cell prioritizing component 198 of FIG. 1.

In conventional wireless networks, when RLF occurs in connected mode, the UE performs cell selection to recover from the RLF. More specifically, as part of cell selection for RLF recovery, the UE may scan the last camped cells and other cells included in the UE's acquisition database (ACQ DB). When none of the cells listed in the ACQ DB are suitable for cell selection, such as there are no adjacent cells or the cells' signal properties such as RSRP are too weak to sustain a connection, the UE may have to perform a more comprehensive frequency band scan to identify a suitable cell or channel to reestablish the connection. This band scan may be time consuming, meaning that the recovery from the RLF can be delayed, sometimes significantly, before an adequate connection can be reestablished. In other cases, the UE may find a suitable cell during RLF recovery that is not a preferred cell. That is to say, in some arrangements a UE may be designated via a preferred cell database or other notification to establish wireless connections by means of a preferred cell feature from a governing standard, for example, or as dictated from a wireless carrier. In these cases, where the UE is limited to the conventional cell selection techniques described herein, a potentially significant delay may occur before the UE can return to the preferred cell. These conventional techniques may reduce overall throughput, both for ordinary connections and those connections involving preferred or special features of the cell.

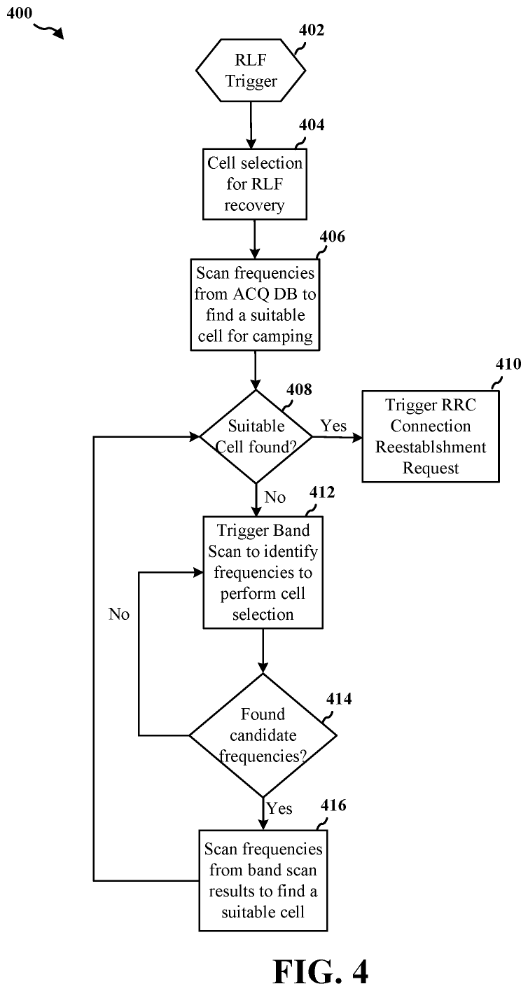

FIG. 4 is a flowchart 400 of a conventional method of wireless communication performed by a UE. It is assumed that at 402, an RLF occurs and the UE identifies a RLF trigger, such as an interrupted connection or dropped call. At 404, the UE may commence a cell selection procedure for RLF recovery 404. At 406, the UE may scan frequencies from an ACQ DB to find a suitable cell for camping. The ACQ DB may include, for example, an historic list of cell previously camped on by the UE. The UE then considers whether a suitable cell has been found from the ACQ DB for which the connection can be reestablished. If a suitable cell has been found that meets the necessary power and signal strength criteria, the UE may trigger a radio resource control (RRC) Reestablishment request at 410. Otherwise, at 412, the UE may trigger a band scan to identify frequencies to perform cell selection. If no candidate frequencies are found, the UE will continue the band scanning. The band scanning may continue until a useable cell is identified. If at 416 the band scan reveals candidate frequencies for possible use in a cell selection, the UE at 416 may thereupon scan the frequencies from the band scan results to find a suitable cell. Once such a cell is found (408), the UE can trigger an RRC connection reestablishment request.

One item of note is, that even if the ACQ DB or the band scan successfully results in a cell selection that yields a reconnection, the process may impose a substantial time delay. Another item is that, if the UE was using a preferred feature (e.g., HST, or an anchor cell supporting LTE-NR ENDC, etc.), finding another suitable cell with the preferred feature may be an arbitrary undertaking. That is to say, the conventional scan focuses on cells with specific link quality criteria, without taking into account cells having preferred features. Reconnection performance can in many cases be sub-optimal as a consequence. One possibility is that none of the cells in the ACQ DB of the UE are strong enough in the location of the RLF, which requires the UE to trigger the time-consuming band scan to find a suitable cell. Another possibility, as noted, is that a UE preferring a feature such as HST (among others) may not be able to recover from the RLF on an HST, cell, which also degrades performance.

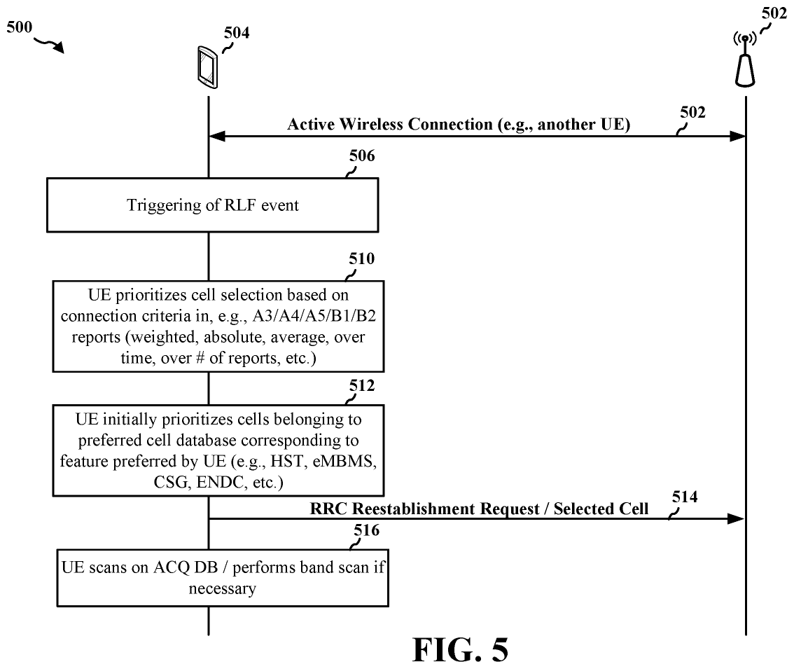

FIG. 5 is a timing diagram showing a basic RLF recovery using certain aspects of the disclosure. The UE 504 can, for instance, be the UE 104 with cell prioritizing component 198 in FIG. 1. In the illustration shown, only one UE 504 is shown, and it is assumed that the UE 504 has established a connection with another unseen device (e.g., another UE) via base station 502. At 506, an RLF event is triggered at the UE 504. At 510, UE 504 may commence cell selection using a prioritization cycle. In the example shown, the UE 504 can use one or more of measurement reports A3, A4, and A5, B1 and B2 to elicit different values from the measurement reports including RSRP, RSRQ, and others. The elicited values or connection criteria may be absolute, or the connection criteria may be instead computed based on the obtained values—a weighted average over some amount of time or some number of received reports at the UE, for example. The measurement reports may reveal cells with highly desirable properties and on which the UE 504 can initiate connection reestablishment, if desired, without the delays and disadvantages associated with relying solely on the ACQ DB and disregarding the measurement reports. In still other configurations, the UE may extend its prioritization to inter-RAT measurement reports, periodic measurement reports and other information in the UE's possession at the time of the RLF. Using this information from the measurement reports and other measurement quantity thresholds for prioritization and comparison purposes, the UE may proceed to prioritize cell selection, e.g., with the highest priority candidate cells being the strongest in power or signal-to-noise ratio and the lowest being the weakest.

In other configurations, at 512, the UE may also prioritize cells not only on the basis of the strength of the cell or its desirable weighted or absolute connection criteria, but on the presence or absence of preferred features that correspond to a preferred feature in the UE's database. Examples include, without limitation, HST, eMBMS, CSG, ENDC, and any other preferred features provided by the applicable standards-governing body or the wireless carrier in use. Thus, for example, the UE may initially prioritize those cells that have preferred cell features, with the candidate cells ideally having the strongest and most desirable RSRP/RSRQ/etc. values along with the most desirable preferred features as the highest priority cells, with less strong preferred cells and/or strong non-preferred cells as the next group in the priority line, and with non-preferred cells and weak cells at the lowest priority. At 514, having identified a candidate cell with the highest priority (which may include a combination of high signal strength and a preferred feature) the UE 504 can send the base station 502 a request for connection reestablishment. Conversely, if the measurement reports do not yield any candidate cells, or suitable candidate cells, the UE can still perform the steps in FIG. 4 of scanning bands on the ACQ DB database (516), followed by the band scan. Thus, aspects of the disclosure can optionally be coupled with the conventional methods, the latter being used solely as an alternative to increase overall likelihood of connection. Unlike conventional techniques, however, this latter alternative can be interrupted if new connection criteria are found concerning a potentially viable candidate cell.

Moreover, the UE 504 has a higher probability of reestablishing the connection after RLF using a preferred cell or a strong cell identified from the readily available measurement reports, and doing so at a faster rate with less delay than conventional techniques.

In some configurations, regardless of whether prioritization takes into account only the link-quality connection criteria in the measurement reports, or whether the connection criteria also includes information identifying the preferred features in the preferred cell database, the UE may require in both arrangements that each of the candidate cells satisfies an initial reference signal threshold (e.g., RSRPₜₕᵣₑₛₕ) to ensure that prioritization does not include weak cells likely to cause additional RLFs. If no such cell has connection criteria exceeding this threshold value in the current measurement reports (e.g., A3, A4, A5), the UE can proceed to resort to the ACQ DB for cell selection, as noted above.

In some configurations, cell prioritization is updated after every measurement report is received at the UE, so that the prioritization information in the UE is as accurate and as up-to-date as possible. In additional configurations, the more recently reported cells can replace older or antiquated cells for the same reporting event type, to further ensure that prioritization of candidate cells remains updated. These techniques can also help assure that preferred features in the vicinity of the RLF are continually updated and tracked for use in cell prioritization. In additional implementations as noted above, the UE may keep track of cells that are reported in the B1 and B2 measurement reports, so that the UE can notify the target radio access technology (RAT) accordingly. The RAT can beneficially make use of these cells when cell selection occurs involving the target RAT. In yet additional implementations, the measurement report-based cell prioritization aspects disclosed herein may be maintained throughout a period, such as throughout the RRC connection until UE goes idle, or until another specified time.

As noted above, in addition to cell prioritization based on cell strength, the LIE can perform RLF recovery on preferred cells. However, the relative importance given different connection criteria may differ, and may be tuned to the needs of a particular carrier. In some configurations, the order of prioritization may occur as follows. First, strong candidate cells reported in A3, A4 or A5 measurement reports may be given the biggest consideration in prioritization. Thereafter, candidate cells that belong to a preferred cell database, depending on the feature preferred by the UE, can be prioritized. In these configurations, it may follow that cells that are both the strongest and that have the most desirable preferred features in the UE database of preferred cells may be initially prioritized at the top of the list. In other embodiments, the two considerations may be partitioned into two sets of prioritizations, with some logical algorithm taking into account the relative importance of the preferred feature at issue versus the relative signal strength corresponding to the cell.

In general, during RLF recovery, the UE should prioritize cell selection to the preferred cell based on the identified ranking as long as the cell also satisfies some threshold RSRP requirement to ensure that weak cells are not prioritized. As part of this solution, the UE may maintain different preferred cell databases that each take into account the cell ID and its specific feature(s), if any (e.g., HST, ENDC, CSG, and the like). In still other configurations, among the strong candidate cells that got reported in the measurement reports, the UE may prioritize these strong cells based on the presence or absence of these strong cells in different feature databases. In other configurations, the UE may consider a single, consolidated database that maintains each of the cells and their supported features.

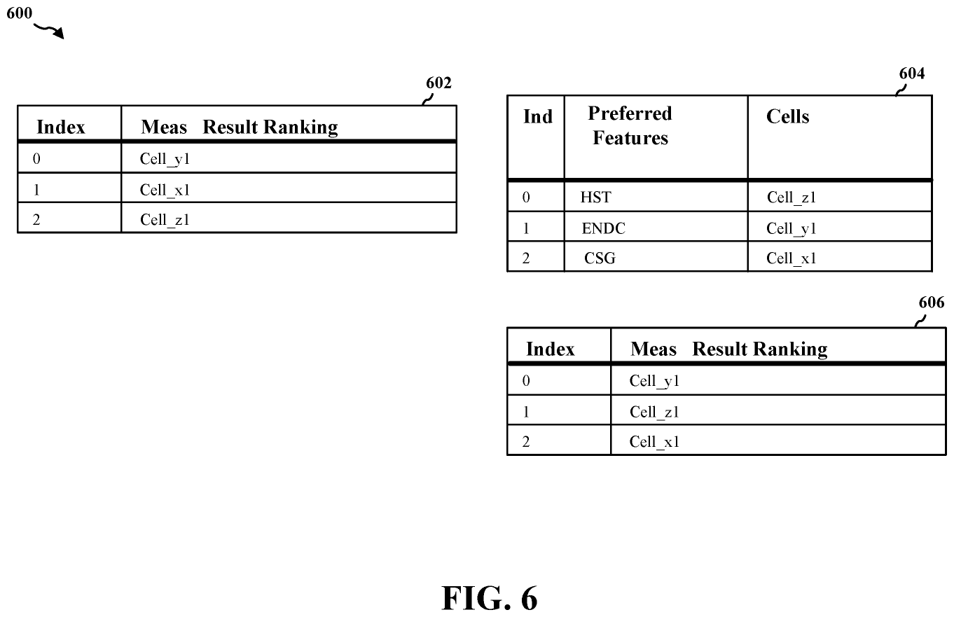

FIG. 6 is a depiction 600 of database or table entries used during cell selection. In one configuration involving cell selection, the data from the measurement reports may be included with entries 602. The following is an exemplary prioritization procedure that may be conducted. In a first configuration, the data in table entries 602 represent prioritized entries from one or more of the measurement reports (MR). The UE is considered to have the following Connected Measurement configuration from the network:
1. MeasId x for MeasObj ID x and reportConfig ID x for MR A3
2. MeasId y for MeasObj ID y and reportConfig ID y for MR A4
3. MeasId z for MeasObj ID z and reportConfig ID z for MR A5

The UE may send measurement reports such that:
cell_x1 with RSRP_x for measId x (such that RSRP_x≥RSRPₜₕᵣₑₛₕ)
cell_y1 with RSRP_y for measId y (such that RSRP_y≥RSRPₜₕᵣₑₛₕ)
cell_z1 with RSRP_z for measId z (such that RSRP_z≤RSRPₜₕᵣₑₛₕ)

In the above situation, RSRP_x, RSRP_y, or RSRP_z may simply be the latest or most recent connection criteria from the MRs; in other configurations they may correspond to values or weighted averages of those values taken over the last time period T or taken over a number N of recent measurements reports. If it is assumed that rsrp_y>rsrp_x>rsrp_z, UE can prioritize cell_y1, followed by cell_x1 before using ACQ DB and during cell selection after an RLF. Cell_z1 would not be prioritized because it does not meet the initial RSRPₜₕᵣₑₛₕ value.

In another configuration below, the UE is considered to have the following connected measurement configuration from the network, as shown in measurement report ranking entries 606 (FIG. 6):
1. MeasId x for MeasObj ID x and reportConfig ID x for MR A3
2. MeasId y for MeasObj ID y and reportConfig ID y for MR A4
3. MeasId z for MeasObj ID z and reportConfig ID z for MR A5

The UE may send measurement reports such that:
cell_x1 with RSRP_x for measId x (such that RSRP_x<RSRPₜₕᵣₑₛₕ)
cell_y1 with RSRP_y for measId y (such that RSRP_y≥RSRPₜₕᵣₑₛₕ)
cell_z1 with RSRP_z for measId z (such that RSRP_z≥RSRPₜₕᵣₑₛₕ)

Unlike the above example, in this case the UE can use optimized RLF recovery on preferred cells reported in the measurement reports. It should be noted that while entries 606 may come from prioritization of the measurement report, in some configurations the entries 604 may be internal information in a UE database tracking the cells and their preferred features.

In the above situation, the connection criteria RSRP_x, RSRP_y, or RSRP_z may also be absolute values or weighted averages taken over the last T time window or N number of measurements reports, as before. If it is now assumed that rsrp_y>rsrp_z>rsrp_x, UE can prioritize cell_z1, followed by cell_y1 before using ACQ DB and during cell selection after an RLF. In this case, cell_x1 would not be prioritized because it does not meet the initial RSRPₜₕᵣₑₛₕ value. The use of preferred features herein may also be influenced by carrier preference, such as in this case, a preference may be mandated by the carrier or standard for use of HST versus ENDC.

Benefits of the above procedure include the ability to identify and prioritize the candidate cells that are reported in Measurement Reports (MRs) during cell selection for RLF recovery, with the knowledge that the UE has been detecting and measuring those same cells in the recent past. In addition, many times when RLF occurs as a result of Handover messages not properly reaching the UE on time due to degraded channel conditions after UE has sent the MR, the proposed solution allows the UE as part of RLF recovery to select the cell to which the network would have most likely handed over the UE. Thus, selecting the cell that is the handover target on a RLF event can be a significant advantage both in time savings and communication quality. These ideas, as noted, need not be specific to one RAT and instead can have equal applicability to 2G/3G/4G/5G, and to future technologies.

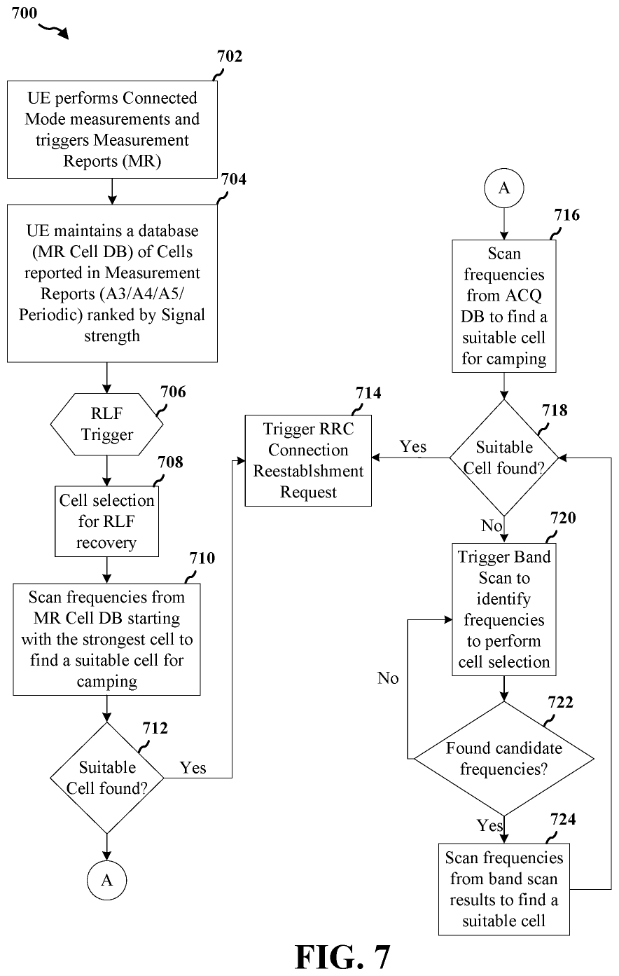

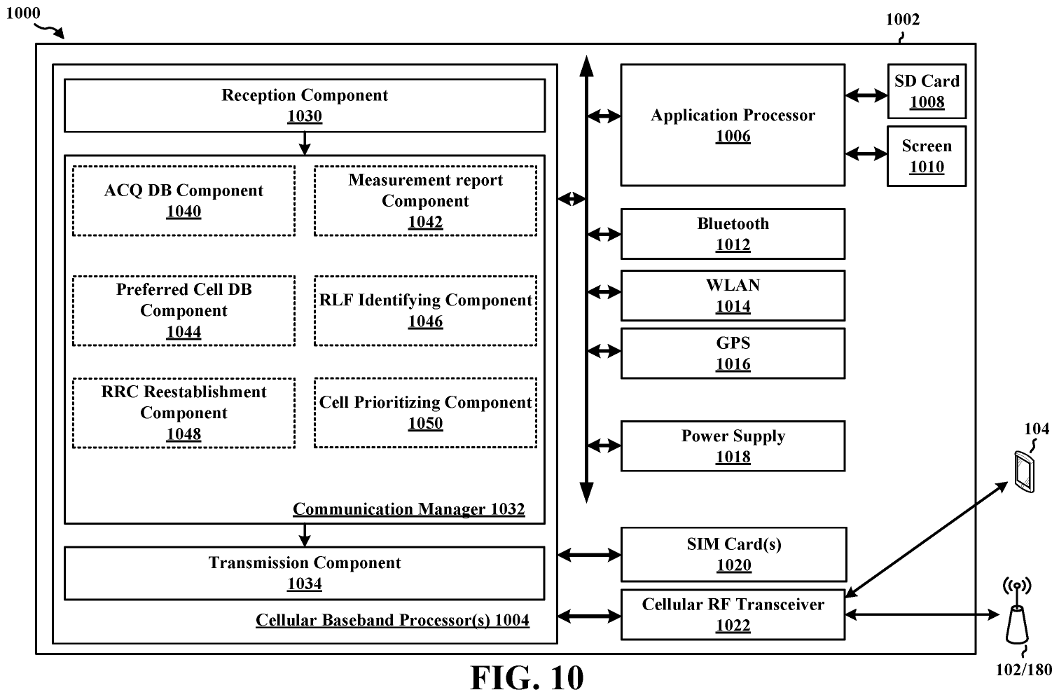

FIG. 7 is a flowchart 700 of wireless communication. The steps in FIG. 7 can be performed, for example, by the UE 104 of FIG. 1 (e.g., using component 198), the UE 350 in FIG. 3, the UE 504 in FIG. 5, and the apparatus 1002 in FIG. 10. At 702, the UE performs connected mode measurements and triggers measurement reports (MRs). At 704, as the UE performs the measurements in 702, the UE can maintain a database (e.g., an MR Cell DB) of cells reported in measurement reports (including, for example, A3/A4/A5/periodic) ranked by signal strength. At 706, it is assumed that a connection is interrupted by an RLF trigger and the connection is lost. At 708, the UE thereupon undergoes cell selection for RLF recovery purposes. In this configuration, however, in lieu of accessing the ACQ DB, the UE at 710 scans frequencies from the above-described MR Cell DB starting with the strongest candidate cell to prioritize the order of candidate cells and find a suitable cell for camping. If a suitable cell is found with adequate levels of signal power, then without further delay, the UE at 714 can immediately trigger an RRC connection reestablishment request.

By contrast, if at 712 a suitable cell is not found (such as none of the prioritized candidate cells in the MRs turn out to be workable here), then control moves to A (FIG. 7). A in this case simply means that the ordinary cell selection procedures take effect. At 716, the UE may proceed to scan frequencies from the ACQ DB to find a suitable cell for camping. A similar procedure at 718 follows as the UE queries whether a suitable cell is found based on the scanned measurements in the ACQ DB. If a suitable cell is found, then at 714 the UE can proceed to trigger an RRC Connection reestablishment request and the connection can be restored. Otherwise, if scanning of the ACQ does not yield a suitable candidate cell in 718, the UE may trigger a band scan to identify frequencies to perform cell selection. If no eligible candidate frequencies are available in 722, the UE may repeat the band scan 720, in some case for however often as necessary. Once candidate frequencies are finally identified in 722, the UE can scan frequencies from the band scan results to find a suitable cell associated therewith, as in 724. Control returns to 718, wherein once a suitable cell is found, the UE can trigger the RRC Connection Reestablishment request at 714. It should be noted that, if during the band scan 720 the UE happens to receive connection criteria relating to a candidate cell, through a measurement report or otherwise, the band scan 720 can be interrupted and the candidate cell analyzed further.

The above example takes into account the signal strength data in the measurement reports (or derivatives therefrom) as corresponding to the connection criteria. In the example below, in addition to the signal strength data, the UE may factor into its prioritization whether the identified cells are compatible with preferred features in use or requested for use by the UE.

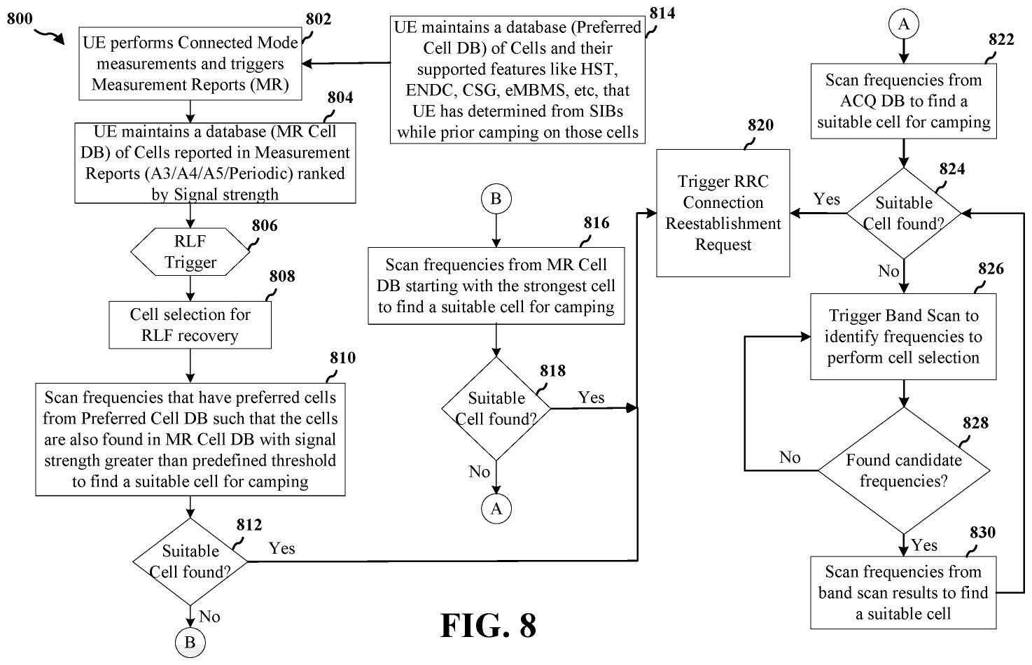

FIG. 8 is a flowchart 800 of wireless communication. The steps in FIG. 8 can be performed, for example, by the UE 104 of FIG. 1 (e.g., using component 198), the UE 350 in FIG. 3, the UE 504 in FIG. 5, and the apparatus 1002 in FIG. 10.

Referring initially to 814, the UE may maintain a database, such as a Preferred Cell DB, identifying cells and their supported features like HST, ENDC, CSG, eMBMS, etc., that the UE has determined from system information blocks (SIBs) during prior camping on those cells. At 802, the UE may perform measurements while in Connected mode and may trigger resulting Measurement Reports (MR) to be received at the UE. At 804, the UE also maintains an MR Cell DB of cells reported in the various measurement reports, ranked by signal strength in this example. Thus, in this configuration, both cell quality and the presence or absence of preferred features are mutually taken into account and can both be connection criteria used to prioritize candidate cells.

Referring still to FIG. 8, it is assumed at 806 that, during a connection, the UE experiences an RLF trigger. The UE initiates cell selection for RLF recovery at 808. In this implementation, however the UE performs cell prioritization by scanning frequencies that have preferred cells from the Preferred Cell DB such that the cells are also found in MR Cell DB with a signal strength greater than some predefined threshold. The UE uses this information to prioritize the candidate cells with preferred features to find a suitable cell for camping and to thereupon select the candidate cell having the highest priority (e.g., the collective best feature(s) and signal quality).

Upon prioritizing the cells as in 810, the UE determines whether a suitable cell is found at 812. If so, the UE can immediately trigger an RRC Connection Reestablishment request at 820, and thereafter restore the connection using the new cell. It is noted that in this case, since the UE had been soliciting MRs earlier in the vicinity (see 814), there is a reasonable possibility that an existing MR has identified an ideal cell in the area. The present disclosure enables the UE to find the cell and to do so with great speed. The prioritization technique also enables the UE to immediately drop from consideration otherwise “preferred” candidate cells that are not strong physical candidates for reconnection because they may not meet, or barely meet, a strength threshold (e.g., RSRPₜₕᵣₑₛₕ).

Referring back to 812, control passes to B if a suitable cell is not found at that point. At 816, the UE may proceed to scan frequencies from the MR Cell DB starting with the strongest cell to find a suitable cell for camping. In this prioritization, the UE has effectively “cast a wider net” by not limiting the search for cells with preferred features, but rather by searching for strong cells that would facilitate a fast reconnection. At 818, the UE may again query whether a suitable cell has been found. If so, then control may return again to 820, in which event the UE may issue an RRC connection reestablishment request. Thus the UE can restore the connection using a strong cell, albeit without necessarily the same preferred features, and the UE can do so with a low latency since it has not yet been required to scan the ACQ DB.

If, by contrast, a suitable cell still has not been found at this point, control goes to A, which means that in this configuration, the UE can still fall back on conventional techniques for restoring the connection. At 822, the UE may proceed to scan frequencies from the ACQ DB to find a suitable cell for camping. At 824, if such a cell is found, the UE can issue an RRC reestablishment request (at 820). Otherwise, at 826, the UE can trigger a band scan to identify frequencies to perform cell selection. If candidate frequencies at 828 are identified, the UE may scan the frequencies at 830 to find a suitable cell, and the cycle repeats at 824. If candidate frequencies at 828 are not yet identified, the UE can resume the band scan at 826.

Thus a worst case scenario as in the above examples is where the UE scans the measurement reports and, based on the connection criteria or on the absence of cells, the UE does not find a viable candidate cell. Overall, however, this process is both likely to yield beneficial results given the constantly updated nature of the measurement reports (which can yield alternatives), and which is not too time consuming because it does not require access to the ACQ DB. If all else fails, as noted above, the conventional techniques for finding a suitable cell always remain an option for the UE meaning that overall, chances of reestablishing a connection and restoring the link after the RLF may be increased.

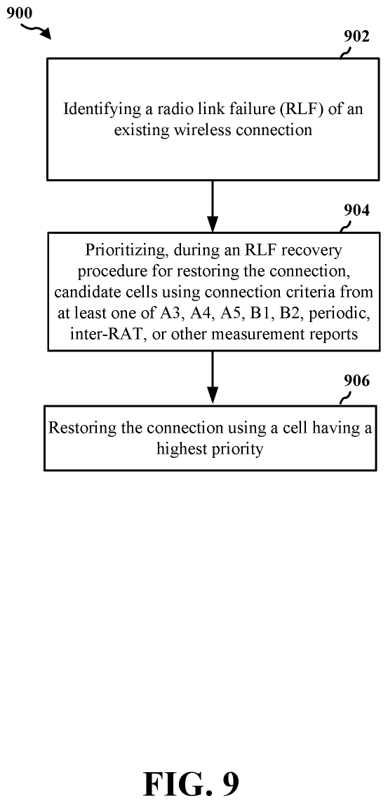

FIG. 9 is another flowchart 900 for wireless communication. Like FIGS. 7 and 8, the steps in FIG. 9 may be performed, for example, by the UE 104 of FIG. 1 (e.g., using component 198), the UE 350 in FIG. 3, the UE 504 in FIG. 5, and the apparatus 1002 in FIG. 10. FIG. 9 takes the constituent steps described with respect to FIGS. 7 and 8 and rewrite them in a more general form. At 902, the UE identifies an RLF of an existing wireless connection. It may be sufficient, for example, that the connection simply drops and the link is terminated. During the ensuing RLF recovery for restoring the connection, the UE may prioritize candidate cells using connection criteria from specific measurement reports. These connection criteria may include values indicative of signal strength, signal to noise ratio, and the nature or quality of channel conditions in general. For example, as previously discussed, one such connection criterion may be a minimum threshold for consideration, such as RSRPₜₕᵣₑₛₕ, to ensure that weak cells are not involved in the prioritization.

Other connection criteria include, for example, values of RSRP, RSRQ, and other measurements from one or more MRs. The connection criteria may be taken as is, or the numbers may be taken over several most recent MRs in the memory of the UE at the time of RLF. For example, the connection criteria need not just be absolute values, but may be weighted or averaged values measured over some period of time T, or measured using some number of previous MRs. Connection criteria from B1 and B2 may be used for forwarding information to specific RATs for subsequent use, and need not necessarily be used for restoring the dropped connection. The connection criteria can be computed quickly and then can be used to prioritize the candidate cells. Connection criteria indicative of a strong connection are typically associated with cells having a higher priority. In configurations where preferred features are taken into account as discussed at length above, the connection criteria may also include the identity of these features, and, if appropriate, a value assigned to a relative importance of these features, depending on factors like their relative importance to the governing standard or to the carrier, whether they were used in the last cell, and other factors. To ensure that weak cells are not considered, connection criteria may also be used to eliminate preferred cells having a strength that does not reach a threshold.

In some configurations, and as seen above with respect to FIGS. 7 and 8, prioritization of candidate cells can be part of an ongoing process. Prioritization may in part occur if, as in step 704 of FIG. 7 or step 804 of FIG. 8, the UE maintains in connected mode a database of cells reported in various measurement reports and ranks the cells by signal strength. This preexisting activity of maintaining an existing repository of prioritized cells may serve to speed up recovery from the RLF. If priority data is already stored, for example, then the prioritizing procedure upon identifying an RLF event can be increased in speed. Prioritization after RLF may just require updating the rankings based on the location of the failure, or augment or modify the existing ranking to incorporate new events. In some configurations, the prioritizing after RLF can involve taking preexisting determinations to the extent possible, and identifying the list of candidate cells based on those preexisting determinations, albeit with any necessary updates or modifications (e.g., to take an average of measurements) performed where necessary.

At 906, the UE may take action to restore the connection using a cell having the highest priority per the connection criteria. For example, if HST is a feature deemed valuable in the context of the UE and the UE finds a cell having high RSRP and RSRQ values, as well as HST capability, these connection criteria may place this identified cell at the top of the ranking. In one configuration, the remaining cells are ranked accordingly and preserved in the memory of the UE in the event of another RLF, or in the event the highest priority cell cannot be used to restore the connection.

The connection may be restored using an RRC Connection reestablishment request, although in other wireless technologies or circumstances, alternatives are possible for restoring the connection using the highest priority cell.

FIG. 10 is a diagram 1000 illustrating an example of a hardware implementation for an apparatus 1002. The apparatus 1002 is a UE and includes one or more cellular baseband processors 1004 (also referred to as a modem) coupled to a cellular RF transceiver 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The one or more cellular baseband processors 1004 communicate through the cellular RF transceiver 1022 with the UE 104 and/or BS 102/180. The one or more cellular baseband processors 1004 may each include a computer-readable medium/one or more memories. The computer-readable medium/one or more memories may be non-transitory. The one or more cellular baseband processors 1004 are responsible for general processing, including the execution of software stored on the computer-readable medium/one or more memories individually or in combination. The software, when executed by the one or more cellular baseband processors 1004, causes the one or more cellular baseband processors 1004 to, individually or in combination, perform the various functions described supra. The computer-readable medium/one or more memories may also be used individually or in combination for storing data that is manipulated by the one or more cellular baseband processors 1004 when executing software. The one or more cellular baseband processors 1004 individually or in combination further include a reception component 1030, a communication manager 1032, and a transmission component 1034. The communication manager 1032 includes the one or more illustrated components. The components within the communication manager 1032 may be stored in the computer-readable medium/one or more memories and/or configured as hardware within the one or more cellular baseband processors 1004.

In the context of FIG. 3, the one or more cellular baseband processors 1004 may be components of the UE 350 and may individually or in combination include the one or more memories 360 and/or at least one of the one or more TX processors 368, at least one of the one or more RX processors 356, and at least one of the one or more controllers/processors 359. In one configuration, the apparatus 1002 may be a modem chip and include just the one or more baseband processors 1004, and in another configuration, the apparatus 1002 may be the entire UE (e.g., see 350 of FIG. 3) and include the aforediscussed additional modules of the apparatus 1002. In one configuration, the cellular RF transceiver 1022 may be implemented as at least one of the transmitter 354TX and/or the receiver 354RX.

The communication manager 1032 includes an ACQ DB component 1040 that is configured to provide a list of one or more frequencies corresponding to cells that the UE was recently camped on, e.g., as described in connection with step 716 in FIG. 7 and step 822 in FIG. 8. The communication manager 1032 further includes a measurement report component 1042 that receives input in the form of UE measurement requests performed in connected mode from one or more components and is configured to provide resulting measurement data to an MR Cell DB, e.g., as described in connection with steps 702 and 704 of FIG. 7 and steps 802 and 804 of FIG. 8. The communication manager 1032 further includes a Preferred Cell DB component 1044 that receives input in the form of supported features determined from SIBs while the UE previously camped on other cells and is configured to submit the identified features to the Cell Prioritizing Component 1050, e.g., as described in connection with steps 810 and 814 in FIG. 8. The communication manager 1032 also includes an RLF Identifying Component 1046 that receives input indicative of a radio link failure from receiving component 1030 and that is configured to initiate a restoring action to restore the failed link, as shown in steps 706 and 708 from FIG. 7, steps 806 and 808 from FIG. 8, and steps 902 and 904 from FIG. 9.

The communication manager 1032 also includes an RRC Reestablishment Component 1046 that receives input in the form of candidate cells from cell prioritizing component 1050 and that is configured to issue an RRC Reestablishment request upon receiving data corresponding to a suitable cell, as shown in steps 714 and 718 of FIG. 7, steps 812 and 820 of FIG. 8, and step 906 of FIG. 9. The communication manager 1032 also includes a Cell Prioritizing Component 1050 that receives input in the form of measurement data from measurement report component 1042 and preferred cell DB component 1044 and that is configured to prioritize the candidate cells as shown in step 904 of FIG. 9, steps 704 and 710 of FIG. 7, and steps 804, 810, 814, and 816 of FIG. 8.

The apparatus 1002 may include additional components that perform some or all of the blocks, operations, signaling, etc. of the algorithm(s) in the aforementioned flowchart(s) of FIGS. 7-9. As such, some or all of the blocks, operations, signaling, etc. in the aforementioned flowchart(s) of FIGS. 7-9 may be performed by a component and the apparatus 1002 may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1002, and in particular the one or more cellular baseband processors 1004, includes means for identifying a radio link failure (RLF) of an existing wireless connection; means for prioritizing, during an RLF recovery procedure for restoring the connection, candidate cells using connection criteria from one or more measurement reports; and means for restoring the connection using the candidate cell having a highest priority.

The aforementioned means may be one or more of the aforementioned components of the apparatus 1002 configured to perform the functions recited by the aforementioned means. As described supra, the apparatus 1002 may include the one or more TX Processors 368, the one or more RX Processors 356, and the one or more controllers/processors 359. As such, in one configuration, the aforementioned means may be at least one of the one or more TX Processors 368, at least one of the one or more RX Processors 356, or at least one of the one or more controllers/processors 359, individually or in any combination configured to perform the functions recited by the aforementioned means.

Aspects of the present disclosure provide optimal cell selection during RLF recovery. As noted above, when RLF occurs in Connected mode, the UE generally performs cell selection to recover from RLF and performs an RRC Connection Reestablishment procedure upon selecting a cell. As part of the conventional cell selection procedure for RLF recovery, the UE may scan the last camped cells identified in the UE's ACQ DB. When none of the cells in the ACQ DB are suitable for cell selection in conventional approaches, UE may resort to time-intensive frequency band scanning to identify a suitable cell. In this case, overall RLF recovery may be delayed. Another shortcoming of existing solutions involves the case where the UE finds a suitable cell during the course of RLF recovery that the UE determines not to be a preferred cell. For example, the UE performing the cell selection may support HST as a preferred node. The UE may spend initial time searching for cells that do not support this feature. In such case, the UE may take an even longer time to identify a preferred cell, which may further delay the overall process to return to a connected state.

In other cases, referring still to the example where the UE has HST in its preferred cell list, RLF recovery may be attempted via non-HST ACQ DB cells in spite of the fact that an A4 measurement report, for example, may identify an HST cell having a stronger signal strength. Accordingly, in these conventional systems, the UE may forego consideration of the HST cell even where the UE includes HST capability for cells in measurement reports with favorable conditions. In addition to the delay associated with the longer cell selection period, the resulting cell selected conventionally may provide a lower throughput, in some cases substantially lower, than the HST cell identified in the A4 measurement report.

Accordingly, to avoid the possibility of sub-optimal performance identified in the example above, when a UE encounters RLF and consequently initiates cell selection, prioritization of cells may be performed on preferred cells. Prioritizing cell selection in this manner may avoid the problem where none of the cells in the ACQ DB are strong enough in the geographical location where the RLF occurred, and the UE may be triggering a time-consuming band scan to find a suitable cell in lieu of trying to recover quickly on stronger cells reported in Measurement reports. In addition, a UE preferring an HST cell may not be able to perform RLF recovery on an HST cell. As another example, a UE preferring an LTE anchor cell (supporting LTE-NR ENDC) may be performing RLF recovery on a non-anchor LTE cell. The principles in this disclosure provide solutions for these shortcomings.

In another examples, cell selection may benefit substantially where any one or more of A3, A4, A5, inter-RAT measurement reports, or periodic measurement reports are initially identified and one or more connection criteria, such as RSRP, RSRQ, or other listed criteria are used to determine cell quality. In these cases, strong cells can be identified in short time periods that have the attributes necessary for reestablishing a high quality connection.

In other configurations, during cell selection where applicable, the preferred cell features, which may include any UE-desirable features identified in a governing standard or specified by a wireless carrier, may be given initial priority such that cells corresponding to the preferred features are searched before other cells during the measurement reports. In this manner, reconnection can be established very quickly using preferred features without the time delays that are conventionally associated with exhausting the UE's ACQ DB, and thereafter (where necessary) incurring further delay with a band scan. Instead, if the cell corresponding to the preferred features has sufficient signal power or otherwise is sufficient under network conditions, the cell having the standardized feature or the carrier-specified feature can be obtained directly from one of the measurement report such that a connection that continues use of the preferred feature can be selected quickly.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Example 1 is a method for wireless communication at a user equipment (UE), comprising identifying a radio link failure (RLF) of an existing wireless connection, prioritizing, during an RLF recovery procedure for restoring the connection, candidate cells using connection criteria from one or more measurement reports; and restoring the connection using the candidate cell having a highest priority.

Example 2 is the method of example 1, wherein the one or more measurement reports comprises at least one of A3, A4, A5, periodic, or inter-RAT measurement reports.

Example 3 is the method of any of Examples 1 and 2, method of claim 1, wherein restoring the connection comprises identifying the highest priority cell to a base station during a radio resource control (RRC) connection reestablishment.

Example 4 is the method of any of Examples 1 to 3, wherein prioritizing the candidate cells using the connection criteria comprises comparing reference signal received powers (RSRP) values corresponding to each of the candidate cells.

Example 5 is the method of any of Examples 1 to 4, wherein prioritizing the candidate cells using the connection criteria comprises comparing reference signal received qualities (RSRQ) values corresponding to each of the candidate cells.

Example 6 is the method of any of Examples 1 to 5, wherein prioritizing the candidate cells using the connection criteria further includes comparing average connection criteria over a time period, or a number of recent reports.

Example 7 is the method of any of Examples 1 to 6, wherein prioritizing the candidate cells using the connection criteria further includes comparing only the candidate cells that satisfy a minimum connection quality threshold.

Example 8 is the method of any of Examples 1 to 7, further comprising updating prioritizing of the candidate cells when an updated one or more measurement reports are received.

Example 9 is the method of any of Examples 1 to 8, wherein prioritizing the candidate cells using the connection criteria further comprises updating cells with more recently reported cells for a same type of reporting event,

Example 10 is the method of any of Examples 1 to 9, further comprising: identifying cells reported in B1 or B2 reports; reporting the cells to a base station using a target radio access technology (RAT); and using one of the reported cells during cell selection when needed for the target RAT.

Example 11 is the method of any of Examples 1 to 10, further comprising maintaining a prioritized list of the candidate cells during a radio resource control (RRC) connection until the UE returns to idle.

Example 12 is the method of any of Examples 1 to 11, wherein prioritizing the candidate cells using the connection criteria further comprises giving initial priority to cells in the one or more measurement reports that are included in a preferred cell database corresponding to a preferred feature supported by the UE.

Example 13 is the method of any of Examples 1 to 12, wherein prioritizing the candidate cells using the connection criteria further comprises giving initial priority to cells in the one or more measurement reports that are included in a preferred cell database corresponding to a preferred feature supported by the UE.

Example 14 is the method of any of Examples 1 to 13, further comprising giving the initial priority to cells from the one or more measurement reports that are included in the preferred cell database only for the cells that satisfy a minimum connection quality threshold.

Example 14 is an apparatus including one or more memories; and one or more processors each communicatively coupled with at least one of the one or more memories, the one or more processors, individually or in any combination, operable to cause the apparatus to: perform any of the steps of Examples 1 to 14.

Example 15 is one or more non-transitory computer-readable media comprising computer-executable code, the code when executed by one or more processors causes the one or more processors to, individually or in combination, perform any of the steps of Examples 1 to 14.

Example 16 is an apparatus including means for performing any of the functions of Examples 1-14.

1. A method for wireless communication at a user equipment (UE), comprising:
identifying a radio link failure (RLF) of an existing wireless connection;
prioritizing, during an RLF recovery procedure for restoring the connection, candidate cells using connection criteria from one or more measurement reports; and
restoring the connection using the candidate cell having a highest priority.

2. The method of claim 1, wherein the one or more measurement reports comprise at least one of A3, A4, A5, periodic, or inter-radio access technology (inter-RAT) measurement reports.

3. The method of claim 1, wherein restoring the connection comprises identifying the highest priority candidate cell to a base station during a radio resource control (RRC) connection reestablishment.

4. The method of claim 1, wherein prioritizing the candidate cells using the connection criteria comprises comparing reference signal received power (RSRP) values corresponding to each of the candidate cells.

5. The method of claim 1, wherein prioritizing the candidate cells using the connection criteria comprises comparing reference signal received quality (RSRQ) values corresponding to each of the candidate cells.

6. The method of claim 1, wherein prioritizing the candidate cells using the connection criteria further includes comparing values of the connection criteria averaged over a time period, or over a number of recent reports.

7. The method of claim 1, wherein prioritizing the candidate cells using the connection criteria further includes comparing only the candidate cells that satisfy a minimum connection quality threshold.

8. The method of claim 1, further comprising updating prioritizing of the candidate cells when an updated one or more measurement reports are received.

9. The method of claim 8, wherein prioritizing the candidate cells using the connection criteria further comprises substituting one or more of the candidate cells with more recently reported cells corresponding to a same type of reporting event.

10. The method of claim 1, further comprising:
identifying cells reported in B1 or B2 reports;
reporting the cells to a base station using a target radio access technology (RAT); and
using one of the reported cells during cell selection when needed for the target RAT.

11. The method of claim 1, further comprising maintaining a prioritized list of the candidate cells during a radio resource control (RRC) connection until the UE returns to idle.

12. The method of claim 1, wherein prioritizing the candidate cells using the connection criteria further comprises giving initial priority to cells in the one or more measurement reports that are included in a preferred cell database corresponding to a preferred feature supported by the UE.

13. The method of claim 12, wherein the preferred feature includes any one or more features defined by a governing wireless standard or specified by a wireless carrier.

14. The method of claim 12, further comprising giving the initial priority to cells from the one or more measurement reports that are included in the preferred cell database only for the cells that satisfy a minimum connection quality threshold.

15. An apparatus for wireless communication, comprising:
one or more memories; and
one or more processors each communicatively coupled with at least one of the one or more memories, the one or more processors, individually or in any combination, operable to cause the apparatus to:
identify a radio link failure (RLF) of an existing wireless connection;
prioritize, during an RLF recovery procedure for restoring the connection, candidate cells using connection criteria from one or more measurement reports; and
restore the connection using the candidate cell having a highest priority.

16. The apparatus of claim 15, wherein the one or more measurement reports comprise at least one of A3, A4, A5, periodic, or inter-radio access technology (inter-RAT) measurement reports.

17. The apparatus of claim 15, wherein the one or more processors, individually or in any combination, are further operable to cause the apparatus to: identify the highest priority candidate cell to a base station during a radio resource control (RRC) connection reestablishment.

18. The apparatus of claim 15, wherein the one or more processors, individually or in any combination, are further operable to cause the apparatus to:
identify cells reported in B1 or B2 reports;
report the cells to a base station using a target radio access technology (RAT); and
use one of the reported cells during cell selection when needed for the target RAT.

19. The apparatus of claim 15, wherein the one or more processors, individually or in any combination, are further operable to cause the apparatus to give initial priority to cells in the one or more measurement reports that are included in a preferred cell database corresponding to a preferred feature supported by the apparatus.

20. The apparatus of claim 19, wherein the preferred feature includes any one or more features defined by a governing wireless standard or specified by a wireless carrier.

21. The apparatus of claim 19, wherein the one or more processors, individually or in any combination, are further operable to cause the apparatus to give the initial priority to cells from the one or more measurement reports that are included in the preferred cell database only for the cells that satisfy a minimum connection quality threshold.

22. A-One or more non-transitory computer-readable media comprising computer-executable code, the code when executed by one or more processors causes the one or more processors to, individually or in combination:
identify a radio link failure (RLF) of an existing wireless connection;
prioritize, during an RLF recovery procedure for restoring the connection, candidate cells using connection criteria from one or more measurement reports; and
restore the connection using the candidate cell having a highest priority.

23. The one or more non-transitory computer-readable media of claim 22, wherein the one or more measurement reports comprise at least one of A3, A4, A5, periodic, or inter-radio access technology (inter-RAT) measurement reports.

24. The one or more non-transitory computer-readable media of claim 22, wherein the code further causes the one or more processors to, individually or in combination, identify the highest priority candidate cell to a base station during a radio resource control (RRC) connection reestablishment.

25. The one or more non-transitory computer-readable media of claim 22, wherein the code further causes the one or more processors to, individually or in combination:
identify cells reported in B1 or B2 reports;
report the cells to a base station using a target radio access technology (RAT); and
use one of the reported cells for cell selection when needed for the target RAT.

26. The one or more non-transitory computer-readable media of claim 22, wherein the code further causes the one or more processors to, individually or in combination, give initial priority to cells in the one or more measurement reports that are included in a preferred cell database corresponding to a preferred feature supported by a user equipment.

27. The one or more non-transitory computer-readable media of claim 26, wherein the preferred feature includes any one or more features defined by a governing wireless standard or specified by a wireless carrier.

28. The one or more non-transitory computer-readable media of claim 26, wherein the code further causes the one or more processors to, individually or in combination, give the initial priority to cells from the one or more measurement reports that are included in the preferred cell database only for the cells that satisfy a minimum connection quality threshold.

29. A user equipment (UE), comprising:
means for identifying a radio link failure (RLF) of an existing wireless connection;
means for prioritizing, during an RLF recovery procedure for restoring the connection, candidate cells using connection criteria from one or more measurement reports; and
means for restoring the connection using the candidate cell having a highest priority.

30. The UE of claim 29, wherein the means for prioritizing is further configured to give initial priority to cells in the one or more measurement reports that are included in a preferred cell database corresponding to a preferred feature supported by the UE.
